(19) United States
(12) Patent Application Publication
(10) Pub. No.: US 2016/0050901 A1
(43) Pub. Date: Feb. 25, 2016

(54) PORTABLE INSECT TRAPPING DEVICE

(71) Applicant: Vincent Pugh, Raleigh, NC (US)

(72) Inventor: Vincent Pugh, Raleigh, NC (US)

(21) Appl. No.: 14/826,516

(22) Filed: Aug. 14, 2015

Related U.S. Application Data
(60) Provisional application No. 62/070,300, filed on Aug. 20, 2014.

(51) Int. Cl. A01M 1/22; A01M 1/04; A01M 1/10

(52) U.S. Cl. CPC A01M 1/223; A01M 1/103; A01M 1/04

(57) ABSTRACT

A device for trapping and eliminating insects, the device comprises a housing comprising an upper portion with a plurality of openings and a base portion. The upper portion comprises a light source disposed at a center of the upper portion of the housing and an electrically charged wire grid surrounding the light source, adapted to electrocute insects upon contacting the wire grid. The device further comprises a removable tray at the base portion, the tray is adapted to receive a pest bait and to collect the electrocuted insects.

### CROSS-REFERENCE TO RELATED APPLICATIONS

This application claims priority to U.S. Provisional Patent Application No. 62/070,300 titled “ZIP-N-ZAP Insect Hotel”, filed in the United States Patent and Trademark Office on Aug. 20, 2014.The specification of the above referenced patent application is incorporated herein by reference in its entirety.

### FIELD OF THE INVENTION

The present invention generally relates to pest control devices and more specifically relates to a portable electrical insect trapping device for attracting, trapping and eliminating both flying insects and crawling insects.

### BACKGROUND

Unwanted insects even by its mere presence not only creates annoyance, but also acts as vectors or carriers of harmful microorganisms. Insect population is a prominent issue especially in outdoor settings such as camping sites, porches, picnics, lawn, etc. Buzzing sound of the insects and insect bites are bothersome aspects which may disturb the ambience. Insects also contaminate food, water and consumable fluids especially when kept in an open condition.

There have been numerous inventions developed to reduce the presence of unwanted insects. These include use of scented candles and torches, insect repellents, sticky flypapers, insect traps, chemical insecticides or pesticides, and the like. In addition, electrical insect lures which utilize light as an attracting means and provide electrocution capabilities for the extermination of insect populations, for example electric grid bug zappers or insect trap devices. However, such devices are limited in their scope of capabilities.

Commercial insect trapping devices generally utilize scent attractants and ultraviolet or fluorescent light to attract insects to a killing mechanism where the insects are electrocuted. These devices are larger in size occupying more space and generally not easily portable. Electric bug zappers by various manufacturers use an electrified grid and an ultraviolet bug light for attracting insects. These devices have the disadvantage of an annoying presence caused both by the exposed light and the sound produced as the insects are killed by contact with the high voltage grid.

Further, dead insects tend to clog in between the grid and scattered around the device, therefore, there is a need for easy disposal of trapped insects, without dismantling the device. Furthermore, conventional insect trapping devices are not suitable for controlling insects of different sizes. For instance, separate products such as pesticides are used for attracting and killing crawling insects such as ants, roaches and the like.

Therefore there is a need in the art for an insect trap which is safe, quiet, portable and efficient. The insect trap configured to capture insects of different sizes and types and disposal of the collected or killed insects should be done without having to dismantle the device.

### SUMMARY

The present disclosure relates to a portable device for trapping and eliminating insects, the device comprises a housing comprising an upper portion and a base portion. The upper portion comprises a plurality of windows allowing insects to enter into the housing and a light source disposed at a center of the housing. An electrically charged wire grid is disposed around the light source, wherein the grid is adapted to electrocute insects upon contacting the wire grid. The device further comprises a removable tray at the base portion, the tray is adapted to receive a pest bait for trapping crawling insects such as ants, roaches. The removable tray also collects the electrocuted insects and is removable by sliding out from the housing for safe disposal of the collected insect carcasses.

In an embodiment, the light source comprises a LED light or UV lamp configured to attract insects. The light bulb and the wire grid are connected to a rechargeable battery for receiving power. The insects are attracted by the light source present in the housing, enters through the windows of the housing and electrocuted upon contact with the electric wired grid. The electrocuted insects are collected at the removable tray at the base portion. In addition, the removable tray further comprises a cartridge for receiving all-purpose pest bait, for attracting and trapping crawling insects at the base portion of the device.

In an embodiment, the housing further comprises a ring attached to the top end, the ring enables to carry the device or hang the device on a support. The housing may further comprise individual switching controls for LED light and UV lamp.

These and other features and advantages of this invention are described in, or are apparent from, the following detailed description of various exemplary embodiments of the apparatus and methods according to this invention.

### BRIEF DESCRIPTION OF DRAWINGS

FIG. 1 illustrates a perspective view of the device for trapping and eliminating insects, according to an embodiment of the present invention.

FIG. 2 illustrates a cut away view of the device for trapping and eliminating insects.

FIG. 3 illustrates a perspective view of the device for trapping insects according to a different embodiment of the present invention.

### DETAILED DESCRIPTION OF PREFERRED EMBODIMENTS

The present disclosure relates to a portable insect trapping device which works on the basis of entrapment and electrocution of insects by an electrically charged wire gird disposed within a housing. The base portion of the housing comprises a removable tray for collecting the electrocuted insects and insect carcasses. The housing of the device may comprise a house or hotel like configuration with multiple levels or tiers and one or more windows at each level, providing an aesthetic appeal as well as plurality of openings allowing insects to enter the trapping device.

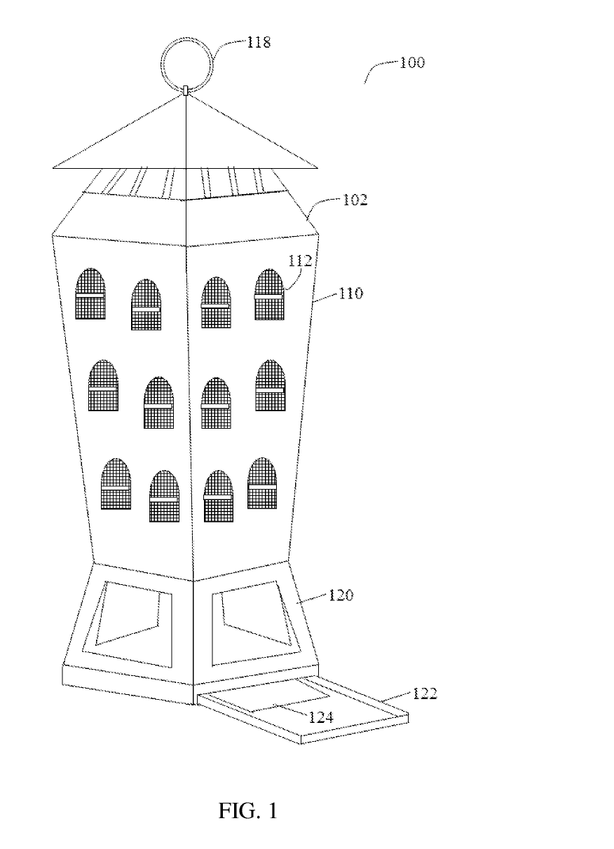

Referring to FIG. 1, which illustrates a front perspective view of the device 100 for trapping and eliminating insects, comprises a housing 102 comprising an upper portion 110 and a base portion 120. The upper portion 110 comprises a plurality of openings 112 allowing insects to enter into the housing 102. The device 100 further comprises a removable tray 122 at the base portion 120, the tray 122 comprises a cartridge 124 adapted to receive a pest bait for trapping crawling insects such as ants, roaches. A ring 118 attached to the top of the housing, for easy carrying of the device 100 or hanging the device 100 on a supporting structure such as a pole.

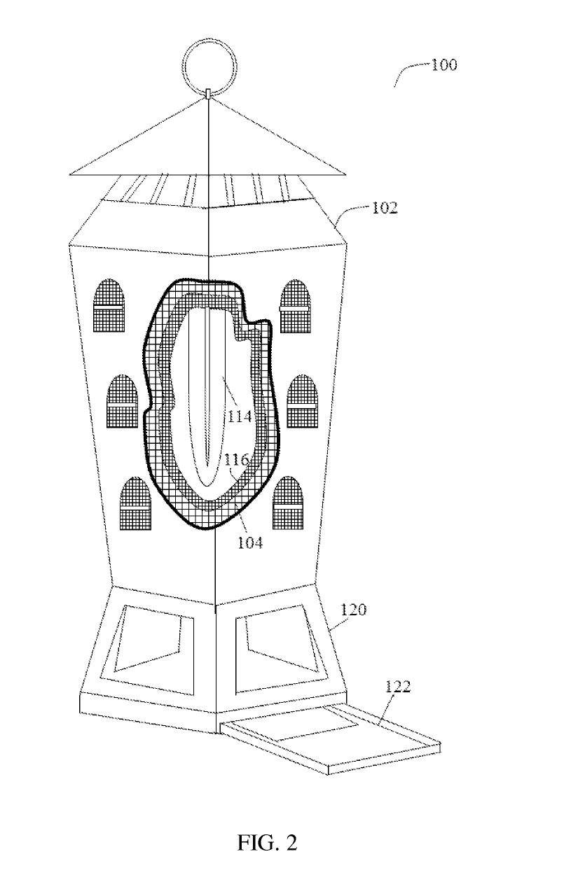

Referring to FIG. 2, illustrating a cut away view of the device comprises a light source 114 disposed at a center of the housing 102. The light source 114 may comprise white LED light or Ultraviolet (UV) lamp or a combination of the two. The light source 114 is configured to attract insects into the housing towards the light source. For example, the light source 114 comprises a 15 watt UV lamp producing one form of UV light configured to attract a first type of insects such as flying insects, the UV lamp can also change to a different form of UV to attract a second type of insects such as cockroaches. An electrically charged wire grid 116 is disposed around the light source 114, wherein the insects entering into the housing 102 are electrocuted upon contacting the wire grid 116. In an embodiment, the electric grid 116 comprises a double layered grid comprising a mesh size configured to capture common insects of varied sizes. The housing 102 comprises a rigid frame 104, made of temperature resistant material for supporting the housing 102. The removable tray 122 at the base portion 120, is adapted to collect the electrocuted insects and is removable by sliding out from the housing 102 for safe disposal of the collected insect carcasses.

In an embodiment, the light source 114 may comprise a switching control for UV lamp and white LED light. The device 100 can be used as a normal lamp or lantern when the white LED is switched on and can be converted into an insect trapping device when the UV lamp is switched on. The housing 102 of the device 100 may comprise individual controls for UV lamp, LED light, and the electrical charged wire grid.

The insect trapping device of the present disclosure may further comprise a rechargeable battery and a power cord. In an embodiment, the battery comprise a Lithium-ion battery and is rechargeable by connecting the power cord to an electrical socket for a predefine period of time. After completion of charging the cord can be detached or winded and concealed into the device. The detachable cord allows easy portability of the device to a variety of locations, including outdoor locations where electrical charging facility is not available.

In an embodiment, the device may comprise a visual indicator showing the battery charge level. For example, the housing may comprise an LED indicator which starts to glows in red when the battery charge level is low or when the device is under charging condition and turns green when charging is completed or when the device is fully charged.

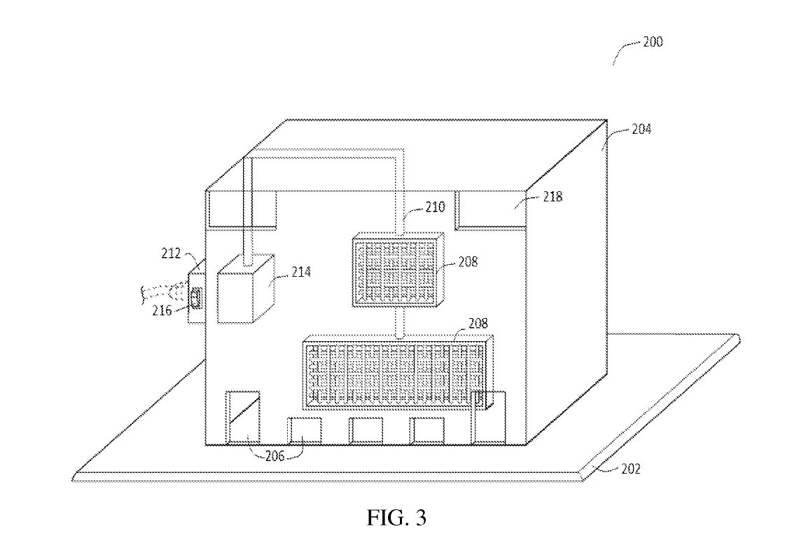

FIG. 3 illustrates a perspective view of the insect trapping device according to a different embodiment. The device 200 supported on a flat base 202, comprises a housing 204 consisting of a plurality of openings 206 at the bottom for allowing insects to crawl inside the housing 204. The housing 204 further comprises a plurality of electric wire grid 208 configured to electrocute insects attracted towards the light source (not shown). An electrical connector 210 connecting the electric wire grid 208 to an electrical socket 212 adapted to receive an electrical charger cord. The electrical socket 212 is operatively connected to a rechargeable battery unit 214 and an operating switch 216. The housing 204 may also comprise a plurality windows 218 on the top portion for allowing flying insects to enter the device 200 for trapping and elimination.

The device of the present disclosure offers numerous advantages including trapping and elimination of insects of different types and sizes ranging from mosquitoes and flies to ants and cockroaches. Cordless configuration with a rechargeable battery enables easy portability and usage of the device in both outdoor and indoor locations, even when electrical outlet is not available in the location. The removable tray at the base portion offers easy removal and disposal of insect carcasses from the device.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

What is claimed is:

1. A portable device for trapping and eliminating insects, the device comprising:
a housing comprising an upper portion with a plurality of openings and a base portion;
a light source disposed at a center of the upper portion of the housing;
an electrically charged wire grid surrounding the light source, adapted to electrocute insects upon contacting the wire grid; and
a removable tray at the base portion adapted to receive a pest bait and to collect the electrocuted insects.

2. The device of claim 1, further comprises a ring attached to the top of the housing.

3. The device of claim 1, further comprises a battery for supplying power to the light source and the wire grid.

4. The device of claim 3, wherein the battery comprises a rechargeable battery.

5. The device of claim 1, wherein the light source is selected from Ultraviolet lamp, LED lamp or its combination.

6. The device of claim 1, wherein the pest bait is configured to attract and trap crawling insects.

7. The device of claim 1, further comprises a power chord connectable to an electric socket.
